(19) United States
(12) Patent Application Publication
(10) Pub. No.: US 2014/0317064 A1
(43) Pub. Date: Oct. 23, 2014

(54) ELECTRONIC DEVICE AND METHOD FOR CHANGING FILE NAME BACKGROUND

(71) Applicant: HON HAI PRECISION INDUSTRY CO., LTD., New Taipei (TW)

(72) Inventor: YING-XIONG HUANG, New Taipei (TW)

(73) Assignee: HON HAI PRECISION INDUSTRY CO., LTD., New Taipei (TW)

(21) Appl. No.: 13/965,216

(22) Filed: Aug. 13, 2013

(30) Foreign Application Priority Data
Apr. 19, 2013 (TW) 102114072

(51) Int. Cl. G06F 17/30

(52) U.S. Cl. CPC G06F 17/30123
USPC 707/687

(57) ABSTRACT

An electronic device and system for changing file names includes a processing unit and a storage unit. The storage unit stores a plurality of files in a number of folders. The processing unit detects the user-selection of a file, acquires from the containing folder any other files with the same attributes, detects whether or there is an operation for changing file name, and controls a file name of the selected file and of any acquired files to be editable when there is an operation for changing file name. The file name of the selected file and of any acquired files is changed to new ordered file names when the selected file is renamed.

### BACKGROUND

1. Technical Field

The present disclosure relates to file management in electronic devices, and particularly to an electronic device and a method for changing name of a file.

2. Description of Related Art

In prior art, when changing a name of a file, the user clicks a right key of a mouse on a desired file name icon, and then clicks a left key of the mouse to render the file name editable, and changes the file name according to a user input. However, although the above method can change the file name of one file, it is time-consuming for changing names of a large number of files according to the above method.

Therefore, what is needed is an electronic device to overcome the above described limitations.

### BRIEF DESCRIPTION OF THE DRAWING

FIG. 1 is a block diagram of an electronic device for changing file name in accordance with an exemplary embodiment.

FIG. 2 shows an example for changing file names of four image files.

FIG. 3 is a flowchart of a file name changing method implemented by the electronic device of FIG. 1.

### DETAILED DESCRIPTION

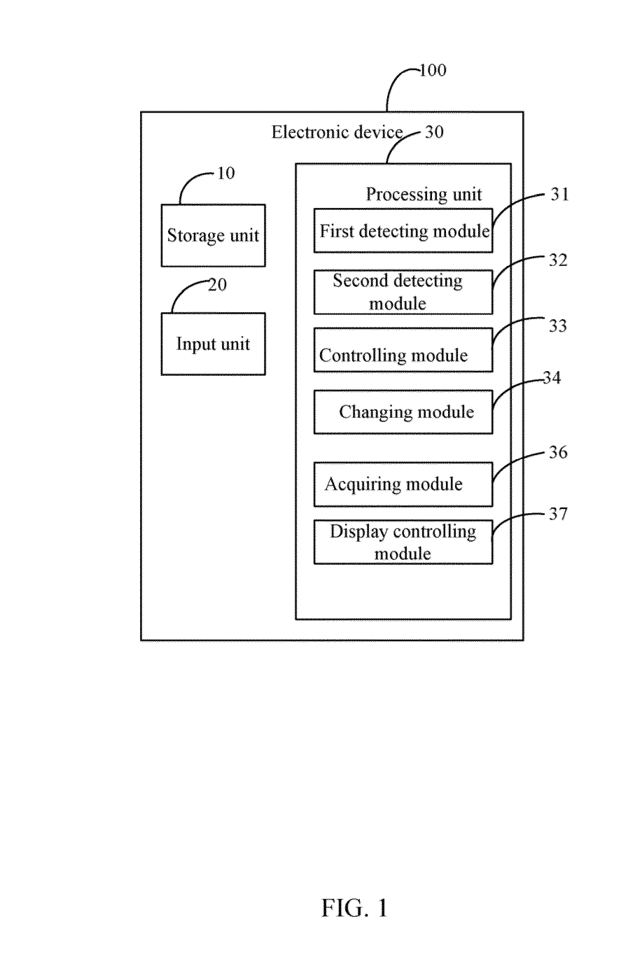

FIG. 1 shows an electronic device 100 for changing name of a file. The electronic device 100 includes a storage unit 10, an input unit 20, and a processing unit 30. The storage unit 10 stores a number of folders. Each folder stores a number of files. Each file is assigned attribute information. In one embodiment, the attribute information includes format of the file, such as MS WORD, MS EXCEL and others. In other embodiments, the attribute information can be defined by user, such as size of the file or creation date of the file. The input unit 20 is used to receive an operation. In one embodiment, the operation can be generated by clicking a left key of a mouse, or by touching a display.

The processing unit 30 includes a first detecting module 31, a second detecting module 32, a controlling module 33, a changing module 34, and a storing module 35 which are collection of software instructions and executed by the processing unit 30.

The first detecting module 30 detects whether or not there is a file selected according to the input operation received by the input unit 20. The second detecting module 32 detects whether or not there is an operation for changing file name of the selected file. In one embodiment, if the operation is a pressing operation, the second detecting module 32 detects whether or not duration of the pressing operation on the file exceeds a predetermined time. If the duration of the pressing operation on the file exceeds the predetermined time, the second detecting module 32 determines that there is an operation for changing file name of the selected file, otherwise, there is no an operation for changing file name of the selected file. If the operation is a touching operation, the second detecting module 32 detects whether or not a duration of the touching operation on the file exceeds a predetermined time. If the duration of the touching operation on the file exceeds the predetermined time, the second detecting module 32 determines that there is an operation for changing file name of the selected file, otherwise, there is no an operation for changing file name of the selected file. The controlling module 33 controls a file name of the selected file to be editable when there is an operation for changing file name of the selected file. The changing module 34 changes the file name of the file to a new file name according to a user input when the file name of the selected file is to be editable. The new file name is composed of a number of characters. The character may be letter or number. The new file name includes a first portion and a second portion. The first portion may be letters, numbers or a combination thereof, such as, image 2012 or photo 2013. The second portion is composed of numbers to assist with sorting, such as 01, 02, 03, and 0020.

The processing unit 30 further includes an acquiring module 36. The acquiring module 36 acquires a number of files, which have attribute information the same as the attribute information of the selected file, from the folder which stores the selected file. The acquiring module 36 further acquires the first portion and the second portion of the new file name of the selected file. In one embodiment, the acquiring module 36 obtains and identifies a character of the new file name of the selected file by identifying a last character thereof and moving to the left one character at a time until the obtained character of the new file name is not a number, and takes the obtained characters which are numbers only as the second portion, and takes the remaining characters of the new file name as the first portion. In one embodiment, the changing module 34 takes the first portion of the new file name of the selected file as the first portion of the new file name for each of the acquired files, and assigns a distinctive number as the second portion of the new file name of each of the acquired files, the distinctive number can represent a numerical order of the file ordered according to a file name in the file folder, or can be randomly generated.

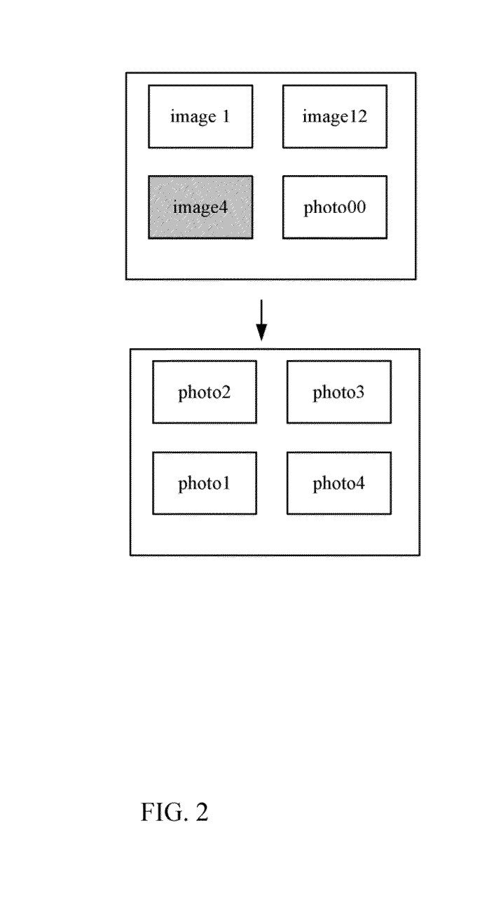

As shown in FIG. 2, there is a folder which stores four image files, the file names are “image1”, “image12”, “image4” and “photo00”. The file format of each of the four image files is JPG. The user selects “image4”, and applies a input operation on the selected file until the file name of the “image4” is editable, and then the file name of the “image4” is changed to the new file name “photo4” according to the user input. The acquiring module 36 acquires other files which have attribute information the same as the attribute information of the “image4” file from the folder. The changing module 34 takes the first portion of the new file name “photo4”, i.e., “photo” as the first portion of the new file name of each acquired files, and assigns a number for each of the acquired files, as the second portion of the new file name of each of the acquired files. For example, the changing module 34 changes the file name “image1” to the predetermined name “photo2”, changes the file name “image12” to the predetermined name “photo3”, and changes the file name “photo00” to the predetermined name “photo4” according to the change method described above.

The processing unit 30 further includes a display controlling module 37. The display controlling module 37 controls a selected file which has an editable file name in a first display manner, for example, by enhancing the color, and controls a selected file which has a non-editable file name in a second display manner which is different from the first display manner.

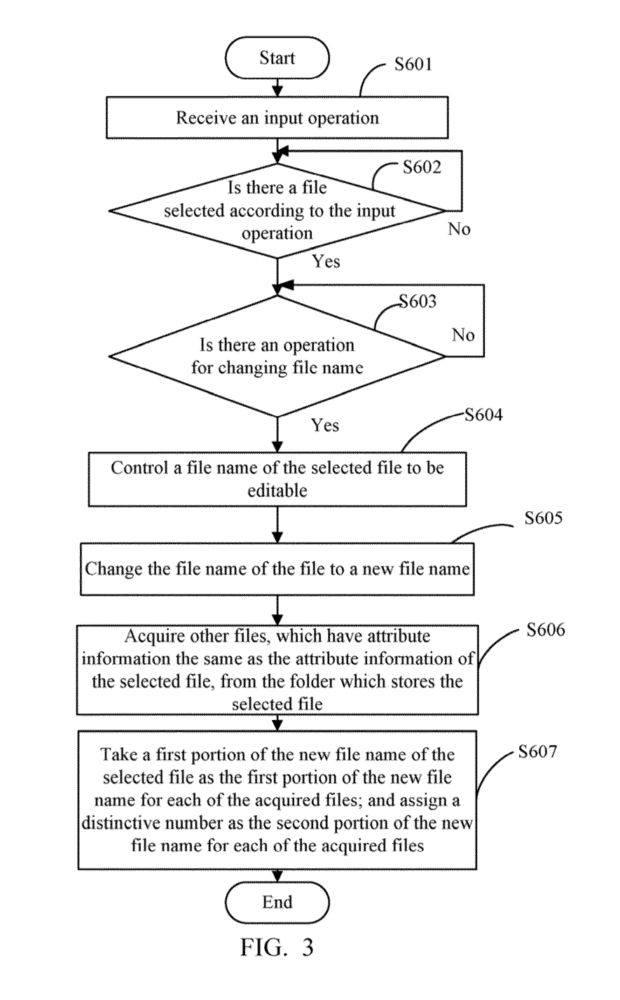

FIG. 3 is a flowchart of a file name changing method implemented by the electronic device of FIG. 1.

In step S601, the input unit 20 receives a input operation.

In step S602, the first detecting module 31 detects whether or not there is a selected file according to the input operation, if yes, the procedure goes to step S603, if no, the procedure goes to step S602.

In step S603, the second detecting module 32 detects whether or not there is an operation for changing file name of the selected file, if yes, the procedure goes to step S604, if no, the procedure goes to step S603.

In step S604, the controlling module 33 renders a file name of the selected file to be editable.

In step S605, the changing module 34 changes the file name of the file to the new file name according to the user input.

In step S606, the acquiring module 36 acquires other files which have attribute information the same as the attribute information of the selected file, from the folder which stores the selected file.

In step S607, the changing module 34 takes the first portion of the new file name of the selected file as the first portion of the new file name for each of the acquired files, and assigns a distinctive and incremental number as the second portion of the new file name for each of the acquired files.

The method further includes sub-step: the display controlling module 37 controls the selected file which has an editable file name in a first display manner, and controls a selected file which has a non-editable file name in a second display manner which is different from the first display manner.

Although various embodiments have been specifically described, the disclosure is not to be construed as being limited thereto. Various changes or modifications may be made to the embodiments without departing from the scope and spirit of the disclosure.

What is claimed is:

1. An electronic device for changing file name of a file, the electronic device comprising:
a storage unit configured to store a plurality of folders, wherein each of the plurality of folders stores a plurality of files;
an input unit configured to receive an operation; and
a processing unit configured to detect whether or not there is a file selected according to the input operation, detect whether or not there is an operation for changing file name when a file has been selected, control a file name of the selected file to be editable when there is the operation for changing file name, and change the file name of the selected file to a new file name according to an user input when the file name of the selected file is to be editable.

2. The electronic device as described in claim 1, wherein the processing unit is configured to detect whether or not a duration of a pressing operation on the file exceeds a predetermined time to determine whether or not there is an operation for changing file name when the operation is the pressing operation.

3. The electronic device as described in claim 1, wherein the processing unit is configured to detect whether or not a duration of a touching operation on the file exceeds a predetermined time to determine whether or not there is an operation for changing file name when the operation is the touching operation.

4. The electronic device as described in claim 1, wherein each of the plurality of files is assigned attribute information, the new file name of the selected file comprises a first portion and a second portion, the processing unit is further configured to acquire a plurality of files, which have attribute information the same as the attribute information of the selected file, from the folder which stores the selected file, and take the first portion of the new file name of the selected file as the first portion of the new file name for each of the acquired files, and assigns a distinctive number as the second portion of the new file name for each of the acquired files.

5. The electronic device as described in claim 4, wherein the first portion of the new file name of the selected file is letter(s), number(s) or a combination thereof, and the second portion of the new file name of the selected file is composed of numbers to assist with sorting.

6. The electronic device as described in claim 5, wherein the distinctive number represents a numerical order of the file ordered according to a file name in the folder.

7. The electronic device as described in claim 5, wherein the distinctive number is to be randomly generated.

8. The electronic device as described in claim 5, wherein the new file name of the selected file is composed of a plurality of characters which comprise letter and number, the processing unit is further configured to obtain and identify a character of the new file name of the selected file by identifying a last character thereof and moving to the left one character at a time until the obtained character of the new file name is not a number, and take the obtained characters which are numbers only as the second portion, and takes the remaining characters of the new file name as the first portion.

9. The electronic device as described in claim 1, wherein the processing unit is further configured to control the selected file which has an editable file name in a first display manner, and control the selected file which has a non-editable file name in a second display manner which is different from the first display manner.

10. A method for changing file name of a file implemented by an electronic device, wherein the electronic device comprises a storage unit and an input unit, the storage unit is configured to store a plurality of folders, each of the plurality of folders stores a plurality of files, the input unit is configured to receive an operation, the method comprising:
detecting whether or not there is a file selected according to the input operation;
detecting whether or not there is an operation for changing file name when a file has been selected;
controlling a file name of the selected file to be editable when there is the operation for changing file name; and
changing the file name of the selected file to a new file name according to an user input when the file name of the selected file is to be editable.

11. The method as described in claim 10, further comprising:
detecting whether or not a duration of a pressing operation on the file exceeds a predetermined time to determine whether or not there is an operation for changing file name when the operation is the pressing operation.

12. The method as described in claim 10, further comprising:
detecting whether or not a duration of a touching operation on the file exceeds a predetermined time to determine whether or not there is an operation for changing file name when the operation is the touching operation.

13. The method as described in claim 10, wherein each of the plurality of files is assigned attribute information, the new file name of the selected file comprises a first portion and a second portion, the method further comprising:
acquiring a plurality of files, which have attribute information the same as the attribute information of the selected file, from the folder which stores the selected file;
taking the first portion of the new file name of the selected file as the first portion of the new file name for each of the acquired files; and
assigning a distinctive number as the second portion of the new file name for each of the acquired files.

14. The method as described in claim 13, wherein the first portion of the new file name of the selected file is letter(s), number(s) or a combination thereof, and the second portion of the new file name of the selected file is composed of numbers to assist with sorting.

15. The method as described in claim 14, wherein the distinctive number represents a numerical order of the file ordered according to a file name in the folder.

16. The method as described in claim 14, wherein the distinctive number is to be randomly generated.

17. The method as described in claim 14, wherein the new file name of the selected file is composed of a plurality of characters which comprise letter and number, the method further comprising:
obtaining and identifying a character of the new file name of the selected file by identifying a last character thereof and moving to the left one character at a time until the obtained character of the new file name is not a number;
taking the obtained characters which are numbers only as the second portion; and
taking the remaining characters of the new file name as the first portion.

18. The method as described in claim 10, further comprising:
controlling the selected file which has an editable file name in a first display manner; and
controlling the selected file which has a non-editable file name in a second display manner which is different from the first display manner.
